(19) United States
(12) Patent Application Publication
(10) Pub. No.: US 2008/0279743 A1
(43) Pub. Date: Nov. 13, 2008

(54) System and method for reducing SO2 emissions of a carbonaceous fuel fired hot gas stream

(76) Inventor: John Byers Rogan, Roswell, GA (US)

Correspondence Address: HOLLAND & KNIGHT LLP, 2099 PENNSYLVANIA AVE, SUITE 100, WASHINGTON, DC, 20006, US

(21) Appl. No.: 12/149,276

(22) Filed: Apr. 29, 2008

Related U.S. Application Data
(63) Continuation of application No. 11/405,572, filed on Apr. 18, 2006, now abandoned.

(51) Int. Cl. B01D 53/50; F01N 3/10

(52) U.S. Cl. 423/244.08; 422/173

(57) ABSTRACT

A system and method of reducing SO₂ emissions of a carbonaceous fuel fired hot gas stream in a system including a precipitator by injecting trona into the hot gas stream prior to the gas stream being cooled by an apparatus such as an air heater.

### BACKGROUND OF THE INVENTION

The present invention relates to reducing the emissions of a hot gas stream, and more particularly to reducing SO₂ emissions of a carbonaceous fuel fired hot gas stream in a power generation system that includes a hot precipitator.

### SUMMARY OF THE INVENTION

The present invention provides a method of reducing SO₂ emissions of a carbonaceous fuel fired hot gas stream in a system including a hot precipitator. A preferred embodiment of the invention includes dispersing trona into the hot gas stream upstream of the hot precipitator; and collecting particulate matter in the hot precipitator. The method of the present invention can be practiced where the temperature of the hot gas stream is in the range of approximately 400° F. to 700° F., and the carbonaceous fuel comprises coal.

The present invention also provides a system for reducing SO₂ emissions that includes a boiler constructed and arranged to combust a carbonaceous fuel and thereby emitting a hot gas stream having a temperature in the range of approximately 400° F. to 700° F.; a duct system operatively connected to the boiler to carry the hot gas stream; an air heater operatively connected to the duct system; another duct system operatively connected to the air heater; a hot precipitator operatively connected to another duct system; and a set of injectors operatively connected to receive trona and being operatively coupled to the duct system in spaced apart relationship so as to inject the trona into the hot gas stream. In a preferred embodiment of the present invention, the carbonaceous fuel comprises coal.

A preferred embodiment of the present invention also can include an injector that includes a pipe member that has a distal end positioned in a hot gas stream emitted from a carbonaceous fired boiler; and a concave member having its concave surface positioned toward the distal end of the pipe and spaced from the distal end of the pipe so that it is offset from a longitudinal axis of the pipe member.

### BRIEF DESCRIPTION OF THE DRAWINGS

FIG. 1 is a schematic representation of a power plant that embodies the present invention.

FIG. 2 illustrates top portions of injectors in a duct system.

FIG. 3 is a side view of the duct system shown in FIG. 2.

FIG. 4 is a chart that shows analysis samples of coal used in tests of an embodiment of the present invention.

FIG. 5 is a graph illustrating the reduction in SO₂ in accordance with an embodiment of the present invention.

FIG. 6 is a chart depicting a summary of testing of an embodiment of the present invention.

FIG. 7 is a chart illustrating the general trona feed rate stoichiometry and corresponding reductions in emissions of SO₂ achieved in accordance with an embodiment of the present invention.

FIG. 8 is a chart illustrating the effect of trona feed rate on the opacity of emissions in an embodiment of the present invention.

FIG. 9 illustrate and exemplary embodiment of an injector in accordance with an embodiment of the present invention.

### DETAILED DESCRIPTION OF THE PREFERRED EMBODIMENTS

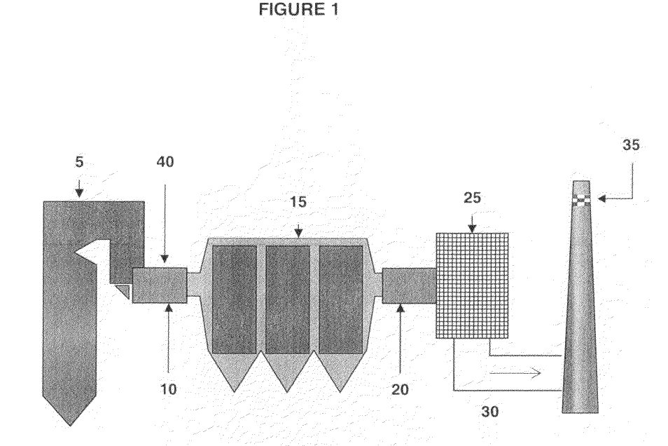

FIG. 1 is a schematic representation of a power plant that embodies the present invention. In the FIG. 1 embodiment, as is well known, a carbonaceous fuel fired boiler 5 heats water that is used to power electrical generators. In one exemplary embodiment, the carbonaceous fuel comprises coal. Combustion of the carbonaceous fuel, such as coal, produces a hot gas stream. That hot gas stream includes combustion particulate matter as well as combustion gases that include, for example, sulfur dioxide (SO₂), sulfur trioxide (SO₃), hydrochloric acid (HCL), hydrofluoric acid (HF), and NOx. The hot gas stream, in an embodiment of the present invention has a temperature approximately 400° F. to 700° F. as it exits the boiler 5.

The hot gas stream passes from the boiler 5 into a duct system 10 that is schematically illustrated in FIG. 1. The duct system 10 can be any suitable duct work needed to transport the hot gas stream along a desired path. In FIG. 1, the duct system 10 operatively connects the boiler 5 to a hot precipitator 15 so that the hot gas stream passes from the boiler 5 to the hot precipitator 15. In the embodiment of FIG. 1, the temperature of the hot gas stream reaching the hot precipitator 15 is in the range of approximately 400° F. to 700° F. The hot precipitator 15, as is well known to those skilled in the art, removes particulate matter from the gas stream.

In the embodiment of FIG. 1, another duct system 20 is operatively connected to the hot precipitator 15 so as to carry the gas stream to an air heater 25. As is well know to those skilled in the art, the air heater 25 preheats air for the boiler 5. The air heater cools the gas stream to a temperature in the range of 250° F. to 400° F. The gas stream then flows through a further duct system 30 to stack 35.

In accordance with the present invention, trona (sodium sesquicarbonate) is injected into the hot gas stream flowing in the duct system 10. The trona is injected in a region 40 of duct system 10. In an embodiment of the present invention, the trona is handled as a dry sorbent. It is pneumatically provided for injection to the hot gas stream as a dry powder via feed tubes. The trona can be any suitable form of trona or trona ore. On example of trona is T-200® available from Solvay Chemicals, Inc. The trona can be injected in a form that it is delivered from a supplier, or can be milled to a suitable particle size as desired for a particular application.

The trona particle size utilized in testing of the present invention ranged from approximately 20 microns to 40 microns. Investigations into the effect the trona particle size on SO₂ reductions achievable with a given amount of trona in accordance with the present invention are ongoing.

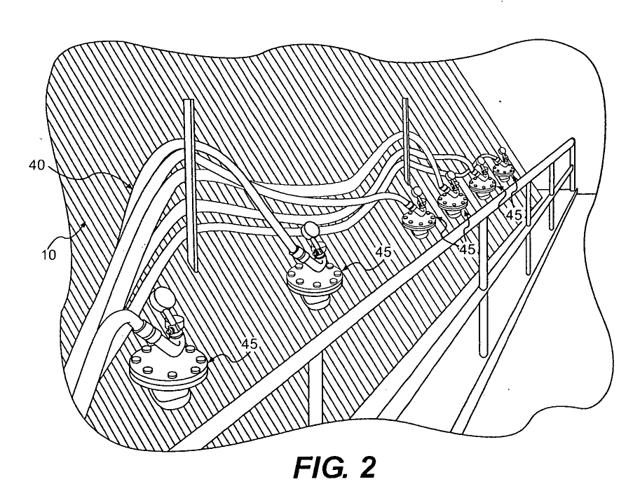

FIG. 2 illustrates top portions of injectors in a duct system. As shown in FIG. 2, trona feed tubes 40 are connected to respective injectors 45. The injectors are spaced apart across a portion the duct system 10 shown in FIG. 2. As shown in FIG. 2, the injectors 45 are mounted to the duct system 10, while not shown in FIG. 2, pass into the interior of the duct system 10 in order to be positioned within the hot gas stream that passes through the duct system 10.

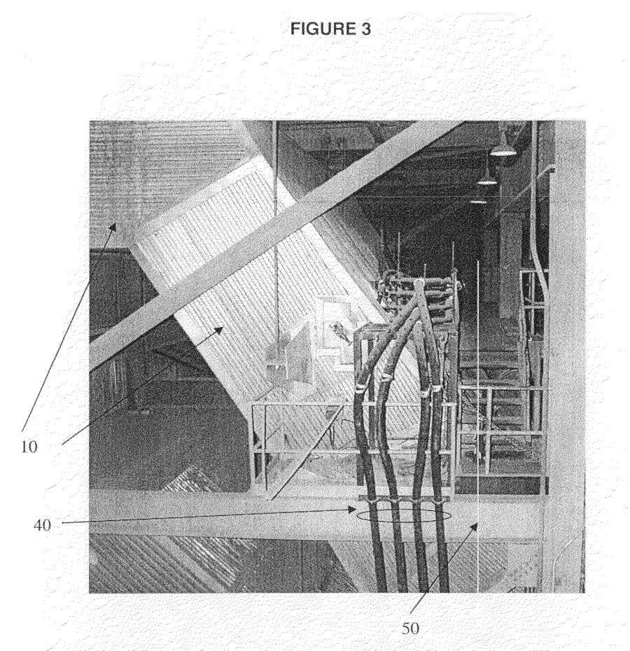

FIG. 3 is a side view of a portion of the duct system 10 shown in FIG. 2. Referring to FIG. 3, the injectors 45 pass into the portion of the duct system 10 in approximately 15 degrees from vertical direction, and thus are at an angle respect to the path of the hot gas stream passing through the duct system 10. In FIG. 3, line 50 approximates a vertical direction. As will be understood by those skilled in the art, the orientation of the injectors with respect to the flow of the hot gas stream depends upon many factors, including for example, the orientation of the duct system and the direction of the gas stream flow, as well as the geometry of the duct system itself.

In testing an embodiment of the present invention, trona is received at the test power generation station on 100-ton enclosed rail cars. The trona was transferred pneumatically from the railcar to a trona feed and injection system. The trona feed and injection equipment used in the tests included the following major components: a trona feed trailer—one truck trailer with four hopper bottom outlets and a nominal maximum capacity of 35 tons of trona; four variable-speed rotary feed valves to meter the trona out of the truck trailer and to feed four 3″ transport hoses; four variable-speed positive displacement blowers with a nominal capacity of 350 scfm each. One blower was used to provide the transport air to one trona rotary feed valve, which transports the trona to the injectors 45 for injection into the hot gas stream within duct system 10.

In the tests, the trona feed trailer was mounted on truck scales, which provided a continuous read out of the trona feed trailer weight with a nominal 10-lb resolution. The total trona feed rate was determined from the rate of weight loss from the trona feed trailer scales. 125. The trona was pneumatically transported through four 3″ hoses to the area of the duct system 10 for injection into the hot gas stream. At the duct system 10, each of the 3″ hoses was split into two 2″ hoses in order to feed two injectors 45. In the tested embodiment, there were eight injectors 45 used in two ducts; each injector 45 being spaced apart across the duct system 10 as shown in the example embodiment of FIG. 2, which illustrates a sample arrangement of the injectors 45.

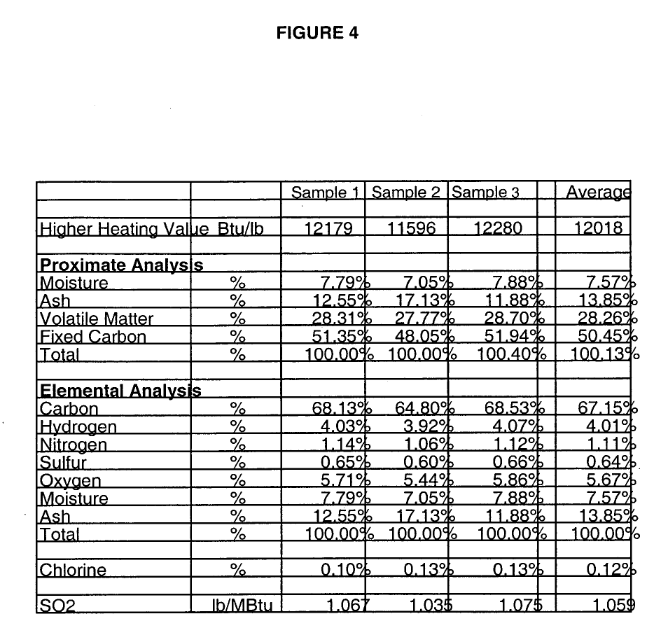

FIG. 4 is a chart that shows an analysis of samples of coal used in tests of an embodiment of the present invention. As FIG. 4 shows, the composition of the various samples of Appalachian coals did not vary greatly. And as a result, the composition did not have a significant impact on the results of the testing. We present the analysis for the benefit of those skilled in the art desiring further data for analysis of the method and system of the present invention.

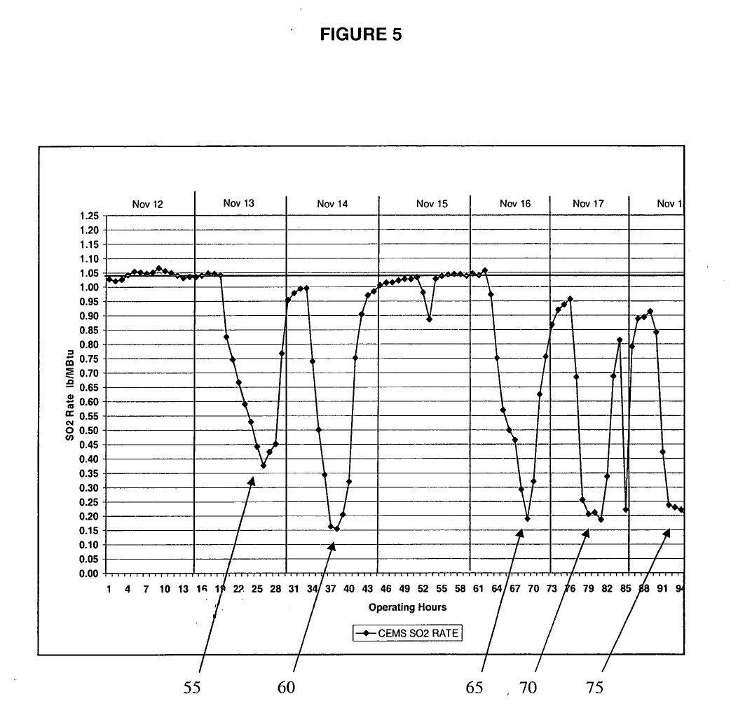

FIG. 5 is a graph illustrating the reduction in SO₂ in accordance with an embodiment of the present invention using Appalachian coal, similar positive results were obtained using Colombian coal. In FIG. 5, a nominal SO₂ emission rate was in approximately 1.05 lbs/MBtu as measured by the stack Continuous Emissions Monitoring System. This shows excellent agreement with the SO₂ measured in the coal analyses shown in FIG. 4. When trona was injected into the hot gas stream in accordance with the present invention, the SO₂ emissions were substantially reduced as noted by points 55, 60, 65, 70 and 75. As noted in FIG. 5, these tests were carried out over a period of days with similar results in the reduction of SO₂ emissions.

To assure accuracy of the testing, prior to beginning the trona injection tests, an EPA-required annual Relative Accuracy Test Audit (RATA) was conducted to demonstrate the accuracy of the permanent stack instrumentation. Due to normal air infiltration into duct systems 10 and 20, the SO₂ concentration in the gas stream is diluted between the boiler 5 and the stack 35. The test analyzers measured O₂ as well as SO₂, and the CEMs analyzers measure CO₂ along with SO₂. SO₂ concentrations were measured at three different locations and the SO₂ concentrations from the three analyzer locations were corrected back to an equivalent 3% O₂ (dry) basis to allow comparison between the measured SO₂ readings at the three locations. The correction factors were derived from the analyses of the actual coal samples taken during the tests. More particularly, The analyses of the three samples shown in FIG. 4 were are all reasonably consistent and the average analysis from these three samples was used as the assumed coal being burned during testing. This average analysis was used to construct the correction curves to correct the various SO₂ measurements back to a consistent basis of 3% O₂ (dry). Also, periodically during the tests, checks were made on the consistency of the SO₂ measurements between the three locations. The test SO₂ measurements at the outlet of the hot precipitator 15 agreed with the CEM'S SO₂ measurements within a maximum variance of 11 ppm, both with and without trona injection, which is excellent agreement. Because of the excellent agreement between the CEMS and the test analyzers, the temporary test analyzers were removed and the CEM'S SO₂ data was used for all subsequent SO₂ removal tests, and is used for all data herein.

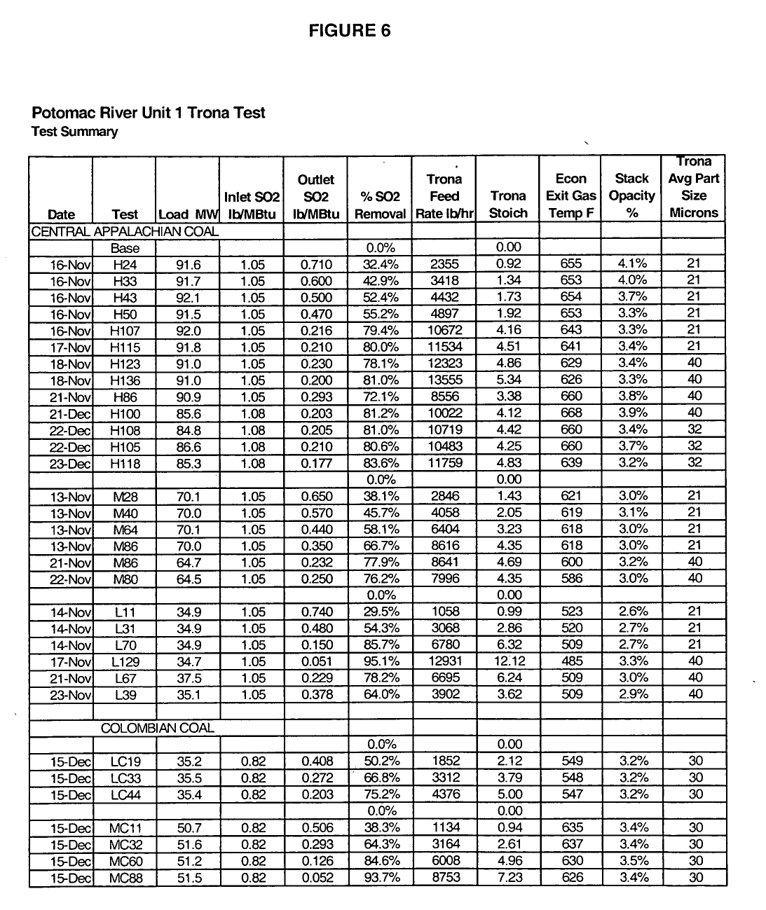

FIG. 6 is a chart depicting a summary of testing of an embodiment of the present invention. More particularly, FIG. 6 provides data for 32 separate tests. The test data are grouped by unit load. High load is at 85 to 92 MW gross, low load is at 34 to 37 MW gross, and mid load is between 50 and 70 MW gross. The data are also shown separately for Central Appalachian coal and the lower sulfur Colombian coal. And, the results are sorted based on the average particle size of the trona being injected during the test.

In FIG. 6, the label for each test indicates the load rate, coal, and trona feed rate. For example, test LC44 indicates:
L=Low load (M=medium load, H=high load)
C=Colombian coal (blank if Central Appalachian coal)
44=Trona feed rate of 4400 lb/hr

In the test results shown in FIG. 6, a stoichiometric feed rate of 1.0 equates to a trona feed rate of 2.354 lb of trona per lb of SO₂ in the inlet gas stream. This is the theoretical quantity of trona required to react with each pound of SO₂ in the entering gas stream. In the test results depicted in FIG. 6, the performance of the hot precipitator 15 was unaffected by the trona injection, and stack opacities under 5% were consistently maintained.

FIG. 6 details the amount of SO₂ emissions reduction and provides the actual trona stoichiometry used in the tests over varying loads. As seen in FIG. 6, the SO₂ content of the hot gas stream prior to addition of trona in accordance with the present invention was approximately 1.05 lbs/MBtu for central Appalachian coal. It was slightly lower with Colombian coal, with a correspondingly lower content of SO₂ in the gas stream after addition of trona in accordance with the present invention.

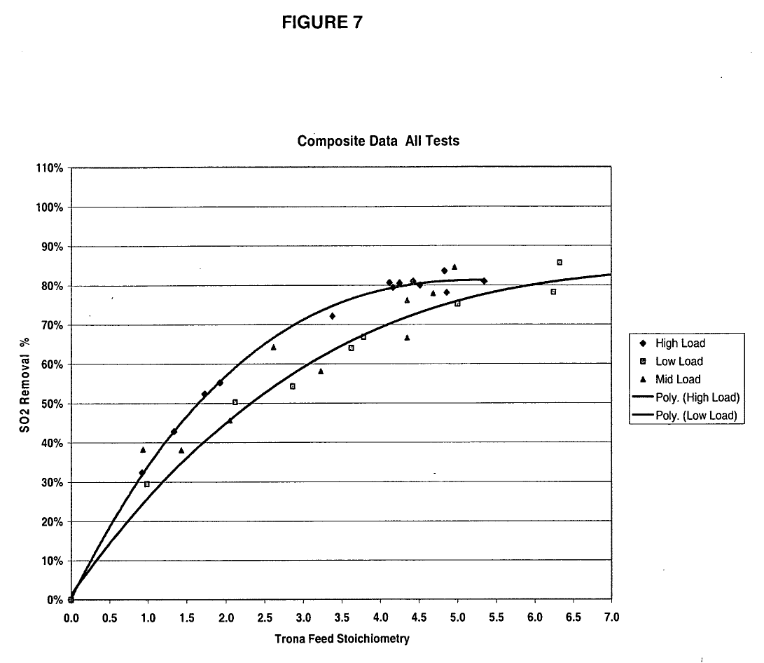

FIG. 7 is a chart illustrating the general trona feed rate stoichiometry and corresponding reductions in emissions of SO₂ achieved in accordance with an embodiment of the present invention. FIG. 7 illustrates, in general form, some of the data presented in FIG. 6, and represent the composite performance for all of the trona injection tests. Referring to FIG. 7, the test results show consistent curves for high and low loads. The consistent performance curves indicate the process is predictable and controllable for the operating conditions during the test.

The trona injection tests did not reveal any significant constraints in achieving an 80% reduction in SO₂ emissions. But, the Colombian coal test did produce some unit operational constraints due to the physical constraints of the equipment at the test site, not the system and method of the present invention. For example, the Colombian coal was lower in sulfur, but its high moisture content and lower heating value resulted in a maximum unit load of only 52 MW due to pulverizer and air temperature limitations to dry the coal.

The trona injection rate required to achieve a given SO₂ removal did vary somewhat between the tests, which reflected differences in the operational variables. The tests indicated that the trona injection rate required to achieve a given SO₂ removal was influenced by some of operational parameters including: trona particle size, gas temperature, inlet SO₂ concentration (due to varying coals used in the tests), trona mixing with the flue gas, residence time between trona injection and particulate removal, and unit load.

Trona injection results in significantly increased ash loading on the hot precipitator 15. At the maximum trona injection rate, the ash load going to the hot precipitator 15 increased by a factor of two to three over the ash load from that due to coal ash alone. As such, a key test objective was to determine if stack particulate emissions or opacity would be adversely impacted from the trona injection. On the favorable side, the hot precipitator 15 used in the tests was very conservatively sized, even by today's standards. Also, as is known to those skilled in the art, sodium based ash (such as trona) lowers the ash resistivity. Lower ash resistivity tends to make ash easier to collect in a hot precipitator 15, improving precipitator performance. However, since the exact process and chemistry involved with the trona and the SO₂ reduction is unknown, the impact of such on the performance of the hot precipitator 15 was unknown.

During the initial trona injection test the trona feed rates were stepped up gradually, which allowed both stable load points for test data, and insured there were no adverse impacts on stack opacity. Over the course of the testing, there was no increase in opacity at all due to trona injection. FIG. 6 shows opacity was under 5% for all of the tests. In order to determine the impact of trona injection on particulate emissions, EPA Method 201A (filterable PM10) and Method 202 (condensable PM10) particulate stack emissions tests were conducted both with and without trona injection. Both tests were conducted at full load (>85 MW gross).

The baseline test runs were conducted without injecting trona in accordance with the present invention. Tests were the run when injecting trona in accordance with the present invention. Trona was injected at a rate high enough to achieve at least 80% SO₂ removal. The data for these 3 test runs are shown on FIG. 6 as tests H100, H105, and H118.

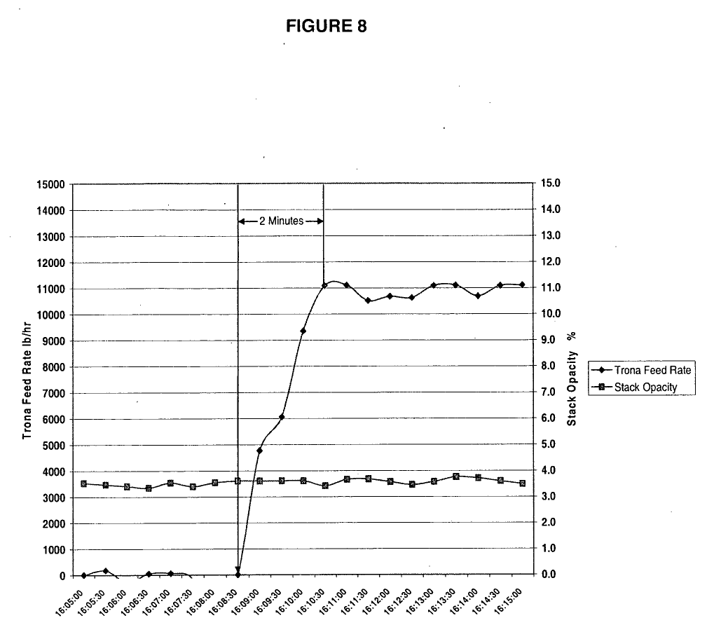

FIG. 8 is a chart illustrating the effect of trona feed rate on the opacity of emissions in an embodiment of the present invention. The testing of the present invention lead to the discovery that the trona injection could be increased as fast as the trona feed equipment could respond and still not change opacity. FIG. 8 illustrates an example of a rapid increase in trona feed rate with no impact on stack opacity. The opacity data in FIG. 8 is shown on 30-second intervals, which shows there were no short-term opacity spikes associated with the rapid increase in trona feed rate.

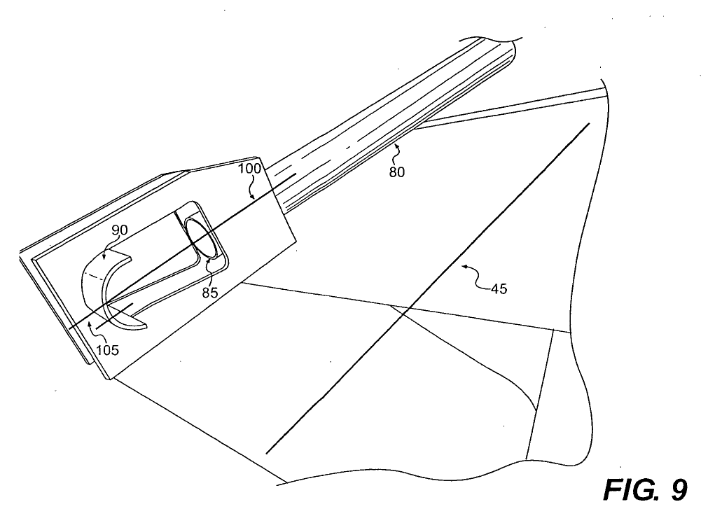

FIG. 9 illustrate and exemplary embodiment of an injector 45 in accordance with an embodiment of the present invention. The injector design used in the tests was determined from computational fluid dynamic (CFD) modeling. See comments on claim 6. In the FIG. 9 embodiment of an injector in accordance with the present invention, the plates that hold the concave member 90 in spaced apart relation to the pipe member 80 are position in parallel with the flow of the hot gas thorough the duct system 10. It will be recognized by those skilled in the art that other suitable mechanism can be used to achieve the desired positional relationship between the concave member 90 and the distal end 85 of the pipe member 80.

What is claimed is:

1. A method of reducing SO₂ emissions of a carbonaceous fuel fired hot gas stream in a system including a hot precipitator, comprising:
a. dispersing trona into the hot gas stream upstream of the hot precipitator; and
b. collecting particulate matter in the hot precipitator.

2. A method of reducing SO₂ emissions of a carbonaceous fired hot gas stream according to claim 1, wherein the temperature of the hot gas stream is in the range of approximately 400° F. to 700° F.

3. A method of reducing SO₂ emissions of a carbonaceous fired hot gas stream according to claim 2, wherein the carbonaceous fuel comprises coal.

4. A method of reducing SO₂ emissions of a carbonaceous fired hot gas stream according to claim 3, wherein step a. includes dispersing trona having an average size in the range of approximately 5 microns to 40 microns.

5. A method of reducing SO₂ emissions of a carbonaceous fired hot gas stream according to claim 3, wherein step a. includes dispersing trona into the hot gas stream with a stoichiometric feed rate in the range of approximately 0.9 to 14.

6. A method of reducing SO₂ emissions of a carbonaceous fired hot gas stream according to claim 3, wherein step a. includes injecting the trona through a pipe, having a distal end positioned in the hot gas stream, and onto a dispersion unit that is offset from a longitudinal axis of the pipe.

7. A method of reducing SO₂ emissions of a carbonaceous fired hot gas stream according to claim 6, wherein the dispersion unit includes a concave member having its concave surface positioned toward the distal end of the pipe.

8. A system for reducing SO₂ emissions: comprising:
a boiler constructed and arranged to combust a carbonaceous fuel and to emit a hot gas stream having a temperature in the range of approximately 400° F. to 700° F.;
a duct system having an inlet operatively connected to the boiler to carry the hot gas stream, and an outlet;
a hot precipitator operatively connected to the outlet of the duct system;
an air heater operatively connected to the hot precipitator;
another duct system having an inlet operatively connected to the air heater and an outlet; and
a plurality of injectors operatively connected to receive trona and being operatively coupled to the duct system in spaced apart relationship so as to inject the trona into the hot gas stream.

9. A system for reducing SO₂ emissions according to claim 8, wherein the carbonaceous fuel comprises coal.

10. A system for reducing SO₂ emissions according to claim 8, wherein the injectors comprise:
a pipe member having a distal end positioned in the hot gas stream; and
a concave member having its concave surface positioned toward the distal end of the pipe and spaced from the distal end of the pipe.

11. A system for reducing SO₂ emissions according to claim 10, wherein the pipe member has a longitudinal axis and the concave member is positioned to be offset from the longitudinal axis.

12. A system for reducing SO₂ emissions according to claim 10, wherein the concave member has a longitudinal axis and that axis is positioned at and angle in the range of more than 0° and 90° with respect to the direction of the hot gas flow.
